(19) United States
(12) Patent Application Publication
(10) Pub. No.: US 2009/0275009 A1
(43) Pub. Date: Nov. 5, 2009

(54) SYSTEM AND METHOD FOR SCHOOL PROGRESS REPORTING

(76) Inventors: John C. Hussey, Dublin, OH (US); Todd A. Hellman, Columbus, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/430,222

(22) Filed: Apr. 27, 2009

Related U.S. Application Data
(60) Provisional application No. 61/126,216, filed on Apr. 30, 2008.

(51) Int. Cl. G09B 7/00

(52) U.S. Cl. 434/322

(57) ABSTRACT

A method of determining staff effect and/or school effect on the educational progress of a student attending the school comprising the steps of selecting, collecting and verifying organizational, staff, and student information; transforming the collected information into data having relationships with other collected information usable by a system; analyzing the related data to produce a computer generated value-added metric that represents the academic growth of a student; and generating a report.

### CROSS-REFERENCES TO RELATED APPLICATIONS

The present application claims priority of U.S. Provisional Application No. 61/126,216 filed Apr. 30, 2008, which is hereby expressly incorporated by reference in its entirety.

### FIELD OF THE INVENTION

The present invention relates generally to the systems and methods for modeling and linking instructional practices in K-12 education organizations for establishing teacher and school staff effect, and, more particularly, is directed to computerized and automated systems and methods for presenting, correcting, capturing, analyzing and modeling teacher and school effects and their effect on student progress and achievement to inform school improvement and/or staff recognition programs such as differentiated compensation (pay-for-performance).

### BACKGROUND OF THE INVENTION

Of the many challenges facing education today is answering the question of “what works?” The complexities of student progress and achievement have proven to be elusive. We often measure what works by discovering what does not work.

One way to try to reveal effective practices is to accurately model the educational environment in which students learn including the teachers (their background, training, experience, etc.) and other professional and operational staff comprising the “school.” Using these models, along with statistical analysis of test scores, the conditions of performance can be correlated to progress and achievement.

When it comes to readying students for success in college and their careers, teachers matter most. Dr. William Sanders' research presented at the Governor's Education Symposium in 2004, suggests that school effect (such as curriculum and administrators) only represent 35 percent of the variability found in student progress; teacher effectiveness (e.g., instructional practice and frequent monitoring) represents 65 percent. [See Sanders, W. L. (2004, June), A summary of conclusions drawn from longitudinal analysis of student achievement data over the past 22 years. Paper presented to Governors Education Symposium, Ashville, N.C., referred to herein as the Sanders' Study, incorporated herein by reference.]

Media attention around teacher effectiveness is increasing, as indicative of articles in Time magazine (Feb. 13, 2008) and EdWeek (Jan. 10, 2008) (each incorporated herein by reference). And, millions of dollars are being invested at the national level to improve teaching and learning. While no one disputes the importance of improving education to ensure that the United States remains competitive in an increasingly flat world, a consensus has not been met regarding how we can best prepare students to thrive.

Schools struggle to recruit and retain great teachers, implement strategies that reveal effective practices and develop teaching talent that will lead to improved student achievement. But, what are effective teaching practices? How can they be identified? And, how can they be replicated to raise progress and achievement for all students?

School systems such as the student information systems (SIS) do not provide efficient or effective ways to accurately link students with teaching/instructional practices. The SIS stops short of modeling the instructional practices of core subject areas which are critical to conduct teacher-level value-added analysis. An SIS provides schedule information and assignment of students to the teacher who is responsible for grade determination—not necessarily all the teachers involved in the instruction and certainly not the entire “school picture” of other professional and support staff. For example, a science lab teacher whose instructional influence is measured as part of the student's “science” grade (both lecture and lab) is not recorded as part of typical SIS practices.

A scalable system is needed to provide linkage of teachers to the instruction students receive in these core subject areas to measure teacher effect and to capture the remaining staff and verify their work to help model school effect—collectively leading to effect on student progress and achievement.

Once accurate student instruction linkage is established, and staff roles have been verified, the analysis can provide highly targeted information about the instructional practices in each subject area and the effect of teachers and professional support specialists on student progress.

In addition, the present invention, sometimes referred to as the Battelle for Kids linkage solution, makes visible to teachers the students that will be used in subsequent statistical analysis—a very important aspect of creating and cultivating commitment to educating students.

Battelle for Kids, a not-for profit corporation located in Columbus, Ohio, has conducted research, honed expertise, developed innovative tools through web-based software and business processes that provide for accuracy in student linkage. In addition, the system accounts for student mobility—not just the students in a teacher's class at the time of the test, but the influence a teacher had on all the students in his/her classroom in a given instructional or testing year.

Teacher effect through linkage and value-added analysis can help bring clarity to and accelerate school improvement. However, to have maximum impact, value-added must be available to all teachers across all core subject areas and grades, and accurately reflect the instructional practices influencing a student's academic growth. In addition, the entire school staff play a role (35% according to the Sanders' Study) in that growth. The present invention enables the modeling of teacher effect and school effect through a system of business processes and software solutions.

### BRIEF DESCRIPTION OF THE INVENTION

The present invention is an instructional linkage and verification system that determines teacher effect and/or school effect on the educational progress of a particular student or students attending the school and taught by the teachers by measuring value-added growth of a particular student or students.

In an embodiment, the invention provides for a method for educational progress reporting by the steps of:

a. collecting organizational data representing organizational hierarchy selected from one or more of state, state regions, school districts, schools, (or by feeder patterns thereof) and the like;

b. collecting staff demographic data;

c. collecting student information data;

d. transforming the collected data from a, b and c into system usable data having selected relationships;

e. expanding the data from step d by linking staff teaching time to individual students for measured courses and/or verifying non-measured teaching and non-instructional job assignments;

f. combining the data from step e with student test results and performing statistical analysis to determine student progress; and

g. associating the students progress with teachers and/or schools.

Another embodiment provides for using the student progress data associated with teachers and schools to determine positive teacher and/or school effects on student performance.

An alternative embodiment includes providing teacher and/or school recognition and/or awards in recognition of the positive teacher and/or school effects.

Another embodiment includes providing assistance to improve teacher and/or school effects based on the positive teacher and/or school effects on student performance.

A yet further embodiment includes reviewing and correcting the transformed data of step d for staff lists; staff assignments; and student rosters.

In an embodiment, the invention provides for a method for collecting information for further use in educational progress reporting by the steps of:

a. collecting organizational data representing organizational hierarchy selected from one or more of state, state regions, school districts, schools, feeder patterns and the like;

b. collecting staff demographic data;

c. collecting student information data;

d. transforming the collected data from a, b and c into system usable data having selected relationships; and

e. expanding the data from step d by linking staff teaching time to individual students for measured courses and/or verifying non-measured teaching and non-instructional job assignments.

Another embodiment includes reviewing and correcting the transformed data of step d for staff lists, staff assignments, and student rosters to ensure data quality.

As used herein “staff” refers to teaching and non-teaching staff.

The methods of the present invention are encoded in software and are processed using computer hardware such as memory, data processors, displays, and the like.

In an embodiment, data to be analyzed is determined, collected, and input into a system, such as but not limited to a computer connected to a network and having a processor, memory, at least one database, and the like. The data comprises student, teacher and school information. The inputted data is verified and relationships between and among the student, teacher and school information are created.

The linked data is analyzed to create value-added metrics. In an embodiment, the value-added metric is a statistical measure of student progress. In an embodiment, the value-added metric is derived using specified performance indicators. In an embodiment, the performance indicators are selected from information such as but not limited to student attendance, student and school achievement data (as measured by standardized tests), longitudinal student and school achievement data (as measured by standardized tests), teacher linkage data (including, but not limited to mobility and percent instructional influence and the like), etc., and combinations thereof. In an embodiment, the value-added metric is determined using a software application that provides a score derived from the specified performance indicators. In an embodiment, the value-added metric is determined using a service provider (ASP)-based program via a network, such as the Internet, over a secure transmission. In an embodiment, the value-added metric is determined using a commercially available product known as EVAAS®. In an embodiment, the value added metric is compared to identified indicators of success to produce a score. The scores are compiled in a report.

### BRIEF DESCRIPTION OF THE DRAWINGS

FIG. 1 is a schematic drawing illustrating the method of the invention.

FIG. 2 illustrates an example listing of staff that are involved in a student's education at a school.

FIG. 3A illustrates an example staff assignment list that shows courses requiring linkage.

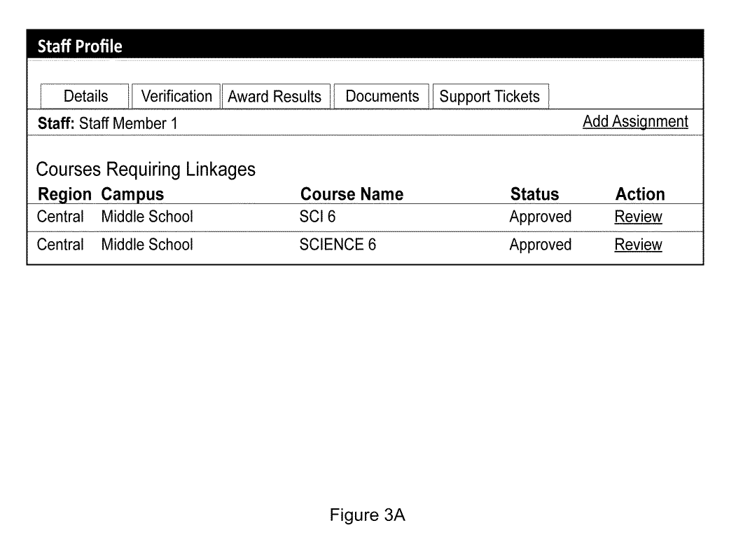

FIG. 3B illustrates an example staff assignment list that shows assignments requiring verification.

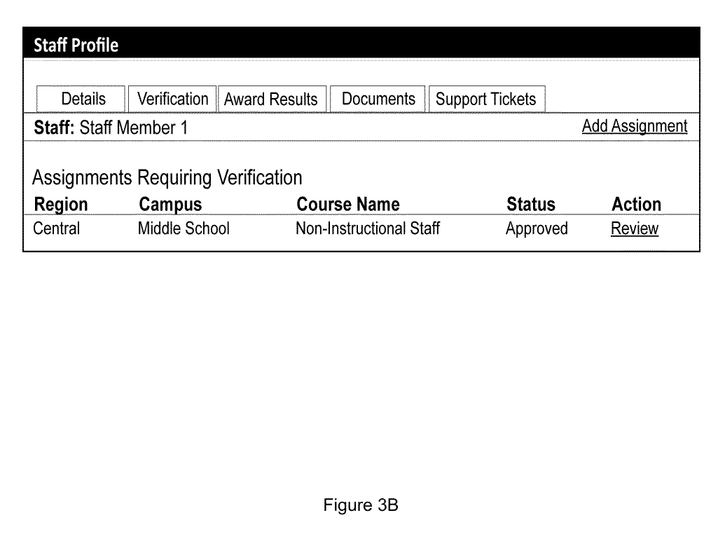

FIG. 4 illustrates an example linkage and instructional verification screen.

FIG. 5 illustrates an example assignment verification screen.

### DETAILED DESCRIPTION OF THE INVENTION AND BEST MODE

The present invention provides systems and methods for the characterization of teacher effect (the educational influence attributable to the teacher for a population of students receiving instruction in a tested subject area) and school effect (the influence of all other non-teaching staff that contribute to the school environment of learning) on student progress and achievement.

Based upon analysis of the teacher and school effects, professional educators and administrators can guide improvement through modeling practices shown to work by providing for professional development of instructional teams or individual staff, and creating continuous improvement plans for further instructional or practice area advancement.

The methods and systems of the present invention typically employ data from multiple sources such as human resources information systems and student information systems that may occur through data importation, data mapping and importation, or data entry.

Subsequent data enhancement and collection occur by the users of the system to view, correct and submit additional data in order to establish the model by which instruction occurred in a school throughout the school year and not just a moment in time.

The present system is useful at all levels (vertical reporting) in the educational system such as hierarchical organization structures (e.g., states have districts that have schools that have staff that have students). The present invention includes reports and other management tools to allow successful program completion by participating users of the system, including staff reports and staff linkage/assignment completion. The typical users of the present invention may include teachers, school administrators, professional staff and other support staff, particularly those associated with K-12 schools.

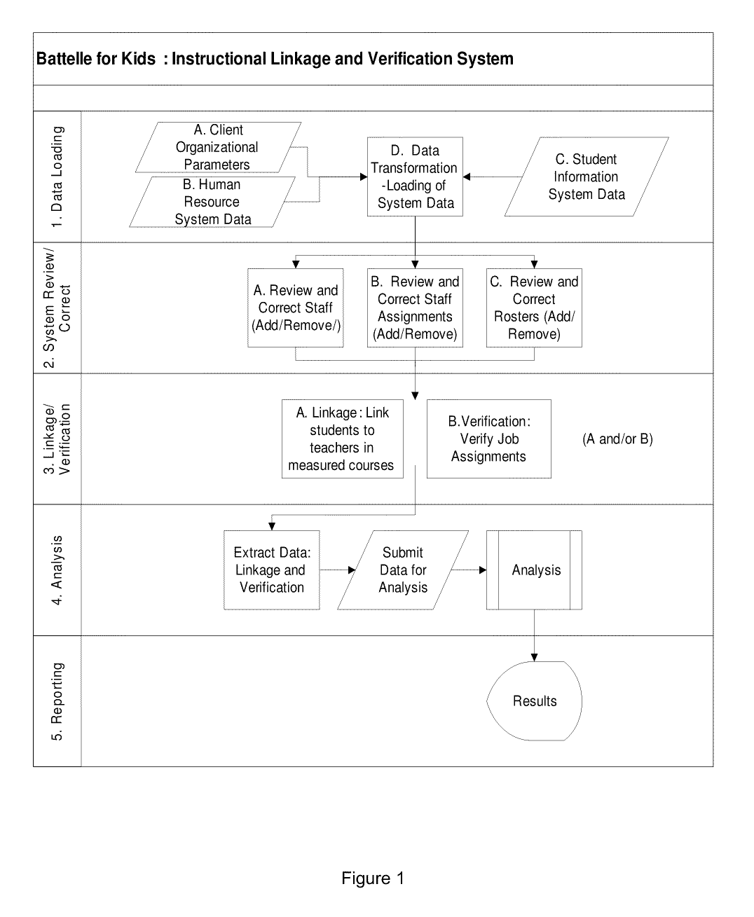

As shown in FIG. 1, in an embodiment, the invention comprises phases. In an embodiment, data is loaded and related in Phase 1. In Phase 2, the data is reviewed and corrected. In Phase 3, the data is linked and verified. In Phase 4, the data is extracted and analyzed. In Phase 5, the results are reported. The following is an outline of the steps of an embodiment of the present invention:

Phase 1:

Data Loading—during this phase of system setup, extracted data is loaded into the system to drive subsequent functionality. The data loading plan in consultation with a client should be created to ensure the system setup will accomplish desired outcomes (e.g., the system will model either teacher effect, school effect or both).
A. Client organization information is loaded to establish the organizational hierarchy that is used for “drill-down” navigation, cascading security and access rights, and associations to staff. The system can handle any number of logical organizational units. For example, a state-level client may contain the state, regions within the state, school districts, schools possibly by feeder pattern such as high schools, middle/junior high schools, elementary schools, and early childhood centers.
B. Staff data, typically from school human resource systems, is extracted to provide an accurate listing of staff, job roles and other optional demographic data (e.g., date of birth, years of experience, teacher education level, or certification). The email address (if available) is associated with the staff information to create the staff's user account or username for login.
C. Student data from the school's student information system (or other authoritative source) is also extracted and loaded into the system to populate a list of unique students by grade level and school, master course schedule with alignment to the standardized test subject, the course schedule with assigned teacher and the student schedule information (alternatively, a student schedule by tested subject with the teacher of record may be used).
D. The data from Phase 1 A-C is loaded into the database and transformed into system data or system data tables in the appropriate tables creating references and selected relationships (e.g., relationships between organization and staff, staff and course, course and student) as defined by the system data schema. Essentially, the transformation takes the data extracts, loads then into the system and transforms data into useful structures for the system operation as described below:
1. Creation of unique organizations and hierarchical relationships.
2. Creation of unique staff records with associated demographics and building the relationships to organizations (e.g., a teacher assigned to a school).
3. Establishes essential (basic) security roles and rights for users in Phase 1.D.2.
4. Creation of unique student records in the student data tables and builds appropriate relationships to organizations.
5. Loads the master course schedule and builds relationships to the tested subjects for measured courses (i.e., courses that align to standardized test subjects that will be the basis of progress analysis).
6. The staff assignments are created based on course schedule data and staff work assignment data (typically from human resources system data), linkage assignments for linking students to teachers (typically for measured courses) and assignments requiring verification for work assignment.
7. For linkage only, students are placed in the rosters of the staff assignments requiring linkage. Non-teaching staff do not require linkage of students, but typically verify work assignments such as speech therapists, teaching assistants and counselors.

Phase 2:

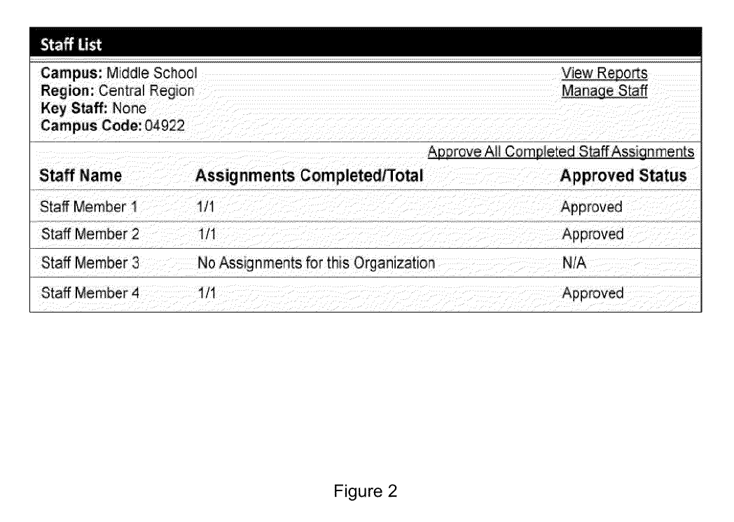

System Review/Correct—The staff list is required to ensure all staff that contributed to either the teacher or school effects are captured. This list should be comprehensive to instructional staff, administrators, professional support, and other support personnel. The system is attempting to model teacher effect and/or school effect. Therefore, a listing of all staff is presented in the staff list (see FIG. 2) that could be loaded from the human resource system data (see FIG. 1; Phase 1.B). The system at this stage allows for correction of that data to accurately reflect the practices at a school and compensate for limitations of many human resource systems (e.g., assigning staff to a pay location versus a work location). Various reports exist to assist the local administrator during the review and correction period for system setup accuracy. In an embodiment depicted in FIG. 2, the present invention creates a listing of staff that are involved in a student's education at a school.

A. Review and Correct Staff (Add/Remove)—The system allows additional review and correction. For example, the local administrators (e.g., a principal of a school) can make changes to ensure all staff are accounted for by reviewing and correcting the staff list. Managing the staff list allows an administrative user the ability to review and correct the staff:
1. Add staff—the system has two ways to add staff to a school:
   a) Search for staff (a person who may be loaded into the system, but did not show assigned to a particular campus), or
   b) Add new staff (when a person is not found within the system). For example staff may be contracted form outside and not in the school human resources system obtained in Phase 1B.
2. Remove a staff member—the system allows the local administrator to remove a staff member from a school staff list if it is incorrect.

B. Review and Correct Staff Assignments (Add/Remove)—Ensuring staff assignments are correct. The staff list page also contains a summary of assignments that have been completed (verified and/or linked) out of the total for a staff person. Additionally, reports are available to display the type of assignment to ensure assignments are correct in the system to accurately model the instructional practices occurring at the school. The local school administrator has the ability to add or remove assignments to correct discrepancies in the data used to load the system. Additionally, one can re-assign a course to another teacher (or duplicate a course for another teacher). An example of a typical assignment correction would be two elementary homeroom teachers, Mrs. Smith and Mr. Jones, who are assigned to teach a group of students in all subject areas. In reality, Mr. Jones teaches his students and Mrs. Smith's students math and science while Mrs. Smith teaches her students and Mr. Jones' students reading, social studies and writing.

C. Review and Correct Student Rosters (Add/Remove)—The accuracy of student rosters (i.e., a list of students in a course) for linkage is critical to system success. Students in the class (or taught by the teacher) should be accounted for throughout the school year. Student mobility is handled in Phase 3: A—Linkage. A typical example of a roster correction may be a science lab teacher who is not recorded in the school's student information as teaching or assigning a grade for science lab because the science lab grade is incorporated into the science class (lecture) grade. Another typical example is that many data extracts may only contain moment in time data (data that exists when the extract occurs). The present system seeks to account for all students in a teacher's class throughout the school year. The present system has functions that allow for roster correction as follows:
1. Add Students—the system has three functions to add students.
   a) Search for missing students (by name, grade level, organization) and add by clicking a checkbox or add link near the student's name.
   B) Copy students from another roster will copy and merge students from a source roster to a destination roster.
2.Add all students within a grade level at a specific school.
3.Remove a student—the system allows the user to remove students from a roster that were not present during the instructional year. A typical example of this is when a student registers for a class, but fails to attend the particular school.

Phase 3:

Linkage/Verification—the linkage/verification process in phase 3 can be performed by a system administrator or individual staff members. It is preferred (but not required) that staff complete their own linkage or verification in order to involve them in the process. Once the linkage and assignment verification are completed by the staff person or other data provider, the school administrators can review, modify and approve the data submitted.

Under Linkage/Verification, the system tasks are:

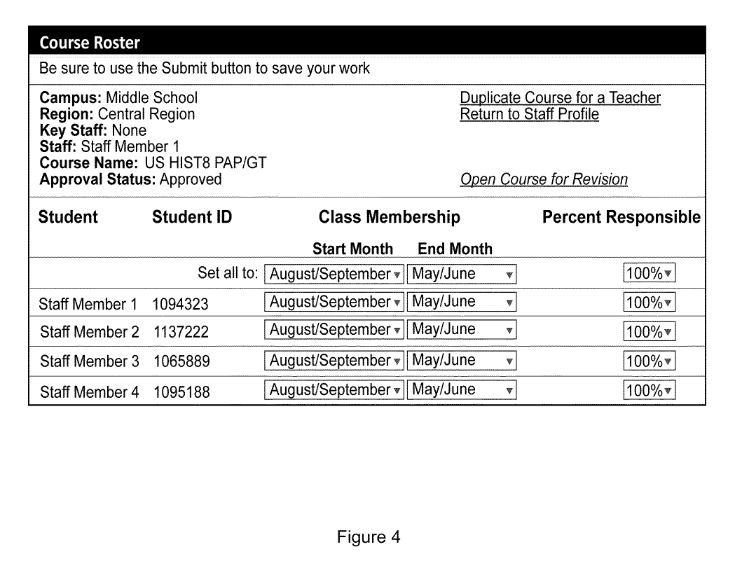

A. Linkage (See FIG. 4)—Linkage is a three step process seeking teacher input in the system for measured courses (i.e., courses aligned to measured or tested content areas).
1. Ensure class roster is accurate and use system tasks (described in Phase 2.C.1 a)-c) and Phase 2.C.2) to make necessary corrections.
2. Indicate membership and mobility by selecting the month a student entered course membership and selecting the month a student ended course membership. The membership indicators' purpose is to determine duration of class membership by using a simple interface to count the number of months. For example, selecting October through January tells the system the student was a member of the course for four months.
3. Indicate the percent responsible for the instruction of each student for the given course and tested subject. If another teacher co-taught the class, the percent responsible would likely be indicated at 50 percent.
4. Submit the data to the system. The system allows changes to be made to the linkage until the local administrator approves the linkage.

In the example shown in FIG. 4, the teacher was responsible for 100 percent of the US HIST8 instruction for the four students from August/September to May/June.

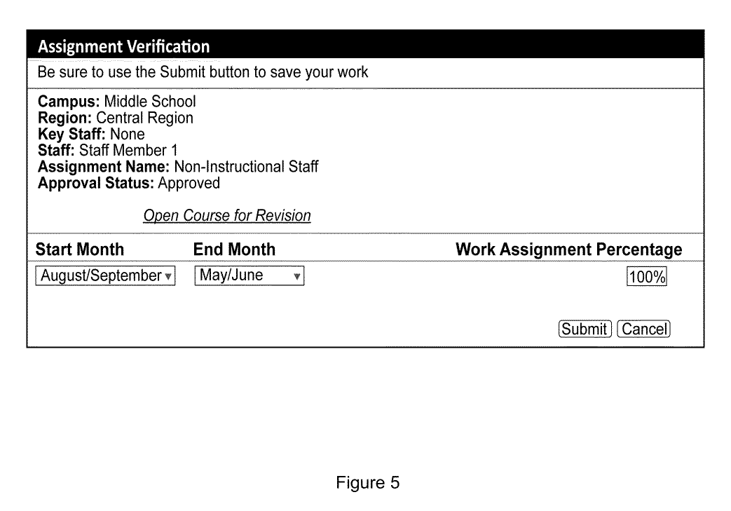

B. Assignment Verification (See FIG. 5)—Assignment verification is a three step process (plus submission) in the system by which staff in non-measured (untested) content areas and/or non-instructional staff (e.g., professional support staff such as the guidance counselor or operational support staff such as a secretary) verify their work assignment.
1. Indicate by selecting the month a staff member began the work assignment for the given school year.
2.Indicate by selecting the month a staff member ended the work assignment for the given school year.
3. Indicate the percent of time during the period the staff member served in the work assignment.
4. Submit the data to the system. The system allows changes to be made until the local administrator approves the assignment.

In the example shown in FIG. 5, the staff person verifies he/she worked as a non-instructional staff (assignment name) from August/September to May/June, 100 percent of the time.

Phase 4:

Analysis—the system collects and validates staff information (Phase 1 and Phase 2) as well as linkage and verification data (Phase 3) for export to analysis. The data is typically combined with student test results and used for various analyses with the following two being the most prominent:

A. Value-Added Progress Measures—Various organizations and systems exist to perform value-added analysis. Value-added is a statistical measure of growth obtained by comparing a student's projected score on a standardized test to his/her actual score. The differences could be positive, negative or not detectably different value-added measures. The data is typically supplied to a statistical organization for analysis or it may be processed in house. A typical program for performing this statistical processing with the present invention is EVAAS®.analysis from the SAS Institute Inc., 100 SAS Campus Drive, Cary, N.C. 27513 (Education Value-Added Assessment System, incorporated herein by reference).

B. Recognition Programs—Trends in education are to recognize highly effective teachers based typically on value-added progress measures produced in Phase 4.A. These programs typically include differentiated compensation programs (i.e., bonus pay) as well as other non-monetary programs. The progress data resulting from the collections in Phases 1-3 and analysis in Phase 4 can be used with a progress-based recognition model to calculate award amounts or spotlight effective teachers for recognition. Additionally, the system can identify (or recognize) struggling teachers for intervention and improvement planning through increased professional development, coaching or other improvement strategies.

Phase 5:

Reporting—once an analysis is performed, the present system takes the results and re-associates with organizations and users. For example, school-level reports will be associated to a school and all users within that school (and higher in the hierarchy) have access to the results. Additionally, individual user awards and other metrics may be reported to the user as determined by the results.

While the forms of the invention herein disclosed constitute presently preferred embodiments, many others are possible. It is not intended herein to mention all of the possible equivalent forms or ramifications of the invention. It is to be understood that the terms used herein are merely descriptive, rather than limiting, and that various changes may be made without departing from the spirit of the scope of the invention.

What is claimed is:

1. A method for educational progress reporting comprising the steps of:
a. collecting organizational data representing organizational hierarchy selected from one or more of state, state regions, school districts, schools, and feeder patterns thereof;
b. collecting staff demographic data;
c. collecting student information data;
d. transforming the collected data from a, b and c into system usable data having selected relationships;
e. expanding the data from step d by linking staff teaching time to individual students for measured courses and at least one of verifying non-measured teaching and non-instructional job assignments;
f. combining the data from step e with student test results and performing statistical analysis to determine student progress; and
g. associating students progress with at least one of staff and schools.

2. The method of claim 1 further comprising the step of using associated data from step g to determine one of staff effect and school effect on student performance.

3. The method of claim 1 further comprising the step of providing at least one of staff and school recognition comprising an award in recognition of at least one of the staff effect and the school effect.

4. The method of claim 1 further comprising the step of providing assistance to improve at least one of staff effect and school effect.

5. The method of claim 1 further comprising the steps of reviewing and correcting the transformed data of step d for at least one of:
a. staff lists;
b. staff assignments; and
c. student rosters.

6. A method for collecting information for educational progress reporting comprising:
a. collecting organizational data representing organizational hierarchy selected from one or more of state, state regions, school districts, schools, and feeder patterns thereof;
b. collecting staff demographic data;
c. collecting student information data;
d. transforming the collected data from a, b and c into system usable data having selected relationships; and
e. expanding the data from step d by linking staff teaching time to individual students for measured courses and at least one of verifying non-measured teaching and non-instructional job assignments.

7. The method of claim 6 further comprising the steps of reviewing and correcting the transformed data of step d for:
1. staff lists;
2. staff assignments; and
3. student rosters.

8. A method of linking and verifying at least one of a staff effect and a school effect on a student attending the school comprising:
a) selecting, collecting and inputting into a computer data to be analyzed, said data comprising student, staff and school information;
b) verifying and correcting the inputted data;
c) using the computer to create relationships between and among the inputted data;
d) analyzing the related data to produce at least one computer generated value-added metric, said metric reflecting at least one of staff effect and school effect on a student; and
e) generating at least one report.

9. The method of claim 8 wherein the computer generated value-added metric is produced using an ASP-based application available via a secured network.

10. The method of claim 9 wherein the application is a software program known as EVAAS.

11. The method of claim 8 wherein the information comprises at least one teacher teaching time for the student.

12. The method of claim 11 wherein the information further comprises non-measured teaching and non-instructional staff assignments.

13. The method of claim 12 wherein the value-added metric comprises a comparison of a projected score on a standardized test for the student to an actual score on a standardized test by the student.

14. The method of claim 13 wherein the projected score is derived from at least one specified performance indicator.

15. The method of claim 14 wherein the specified performance indicator is at least one of student attendance, student achievement data, school achievement data, longitudinal student achievement data, longitudinal school achievement data, and teacher linkage data.

16. The method of claim 15 wherein the teacher linkage data is at least one of student mobility and percent instructional influence in tested subject areas.
